(19) United States
(12) Patent Application Publication
(10) Pub. No.: US 2014/0255131 A1
(43) Pub. Date: Sep. 11, 2014

(54) HANDLING DEVICE

(71) Applicants: HON HAI PRECISION INDUSTRY CO., LTD., New Taipei (TW); FU DING ELECTRONICAL TECHNOLOGY (JIASHAN) CO., LTD., Zhejiang (CN)

(72) Inventors: HONG-TAO GE, Jiashan (CN); XIANG-TAO ZHANG, Jiashan (CN); LONG-FEI LI, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/191,461

(22) Filed: Feb. 27, 2014

(30) Foreign Application Priority Data
Mar. 11, 2013 (CN) 2013100760912

(51) Int. Cl. B25J 11/00

(52) U.S. Cl. CPC B25J 11/00
USPC 414/225.01

(57) ABSTRACT

A handling device includes a support seat defining an inserting hole, a first driving member, and a handling assembly. The first driving member is assembled to the support seat and is aligned with the inserting hole. The handling assembly includes a mounting seat, a transmission subassembly, a second driving member, and a suction subassembly. The mounting seat is assembled to a side of the support seat opposite to the first driving member, the mounting seat is adjacent to the inserting hole. The transmission subassembly is assembled to the support seat. The second driving member is assembled to the mounting seat and connected to the transmission subassembly. The suction subassembly is assembled to the transmission subassembly. Wherein the first driving member extends through the inserting hole and supports a workpiece, the suction subassembly sucks the workpiece, the second driving member drives the transmission subassembly to handle the workpiece to a workstation.

### BACKGROUND

1. Technical Field

The present disclosure relates to an assisting mechanism for machining, and more particularly, to a handling device for transferring material automatically.

2. Description of Related Art

As a development of automatic machining technology, the manual machining procedures are substituted by automatic or automated machining procedures. However, in the automatic/automated machining procedure, workpieces may still need to be handled manually. It is difficult for operator to control the feeding time of the workpieces for the workstation, as a result, the feeding of workpieces may be disturbed or interrupted between one workstation and a another workstation, thus it is time consuming.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a handling device.

FIG. 2 is similar to FIG. 1, but viewed from another aspect.

FIG. 3 is an isometric, exploded view of the handling device of FIG. 1.

### DETAILED DESCRIPTION

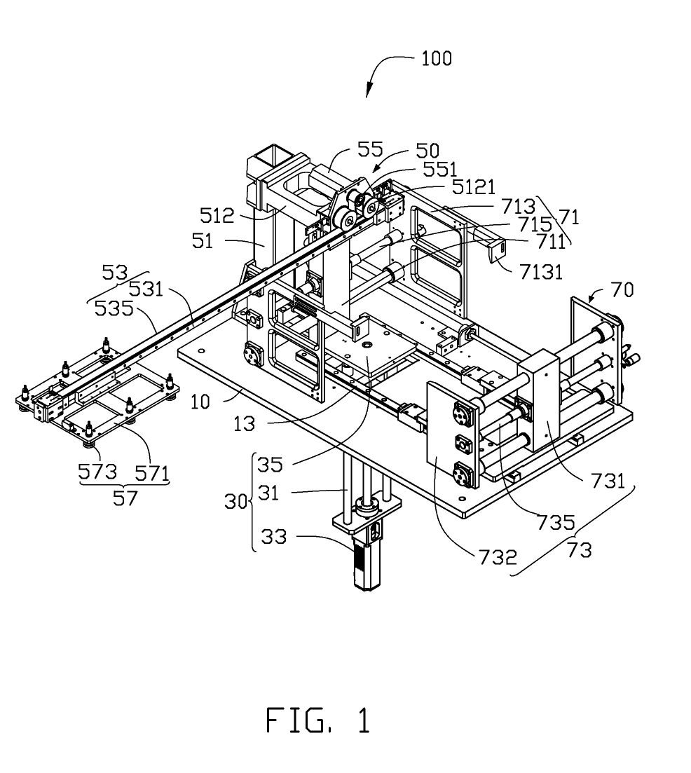

FIG. 1 shows an embodiment of a handling device 100 employed to handle workpieces (not shown) stacked together one by one to a workstation (not shown) nearby, in a constant speed. The handling device 100 includes a support seat 10, a push assembly 30, a handling assembly 50, and an uploading assembly 70. The push assembly 30 is movably assembled to the support seat 10, the handling assembly 50 is assembled to the support seat 10 and partially located above the push assembly 30. The uploading assembly 70 is assembled to the support seat 10 and is partially located below the handling assembly 50 for transferring the workpiece to the push assembly 30. The push assembly 30 pushes the workpiece toward the handling assembly 50, and then the handling assembly 50 transfers the workpiece to the workstation.

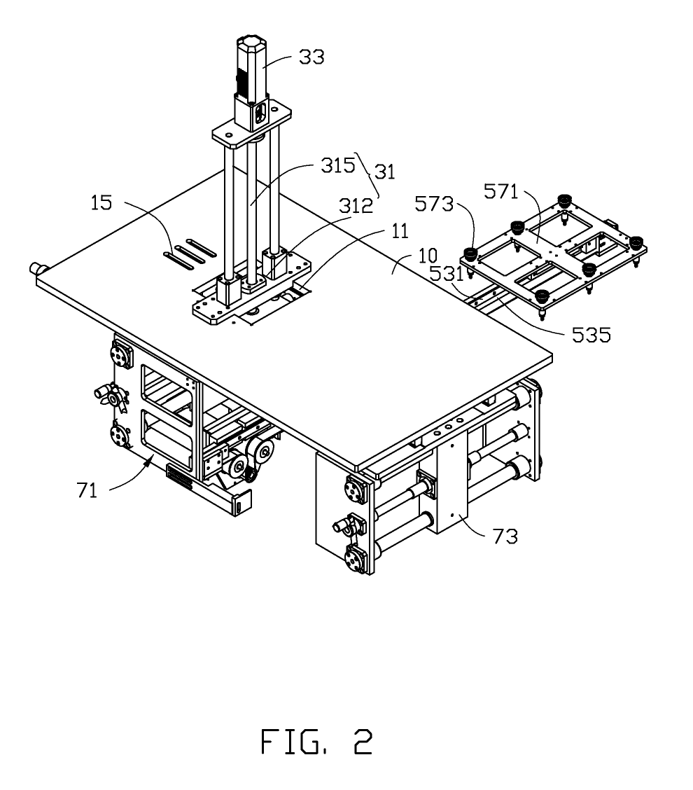

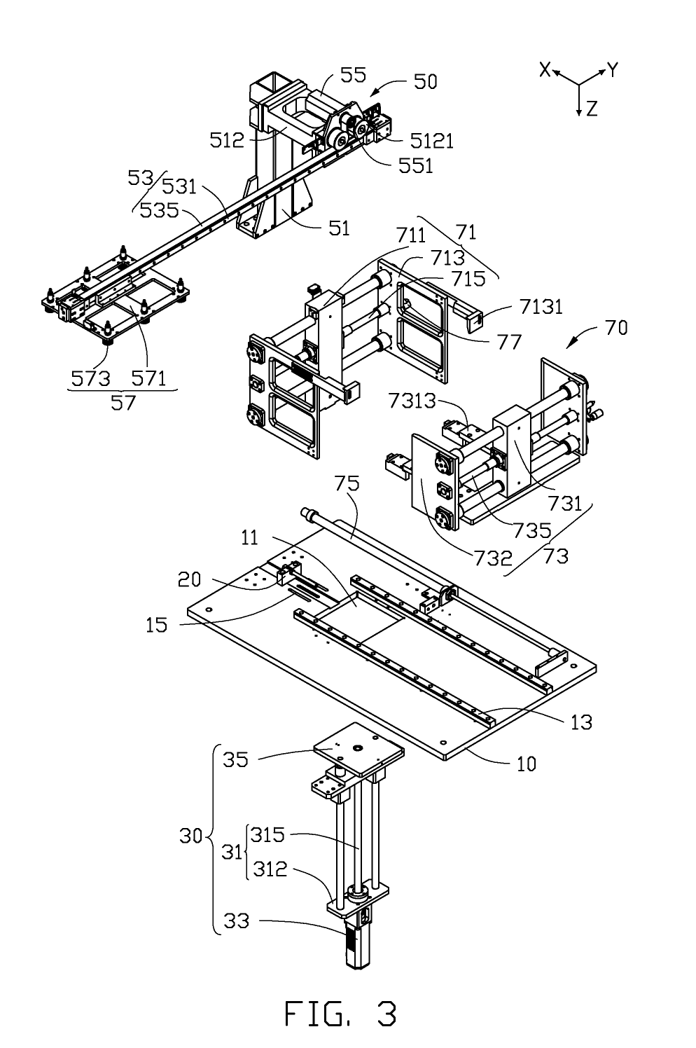

FIGS. 2 and 3 show that the support seat 10 is substantially rectangular and defines an inserting hole 11 cutting through opposite sides of the support seat 10. The support seat 10 is equipped with a pair of guiding rails 13 and defines a plurality of sliding grooves 15 adjacent to the inserting hole 11. The pair of guiding rails 13 are parallel to each other, and the inserting hole 11 is located between the pair of guiding rails 13.

The push assembly 30 is assembled to the support seat 10 and movably passes through the inserting hole 11. The push assembly 30 includes a transmission member 31, a first driving member 33, and a support member 35. The transmission member 31 extends into the inserting hole 11 of the support seat 10, and includes a fixing bracket 312 and a push rod 315. The fixing bracket 312 is fixedly assembled to a side of the support seat 10 opposite to the pair of guiding rails 13, and is aligned with the inserting hole 11. The push rod 315 is slidably inserted into the fixing bracket 312 and is partially extended out of the inserting hole 11. In the embodiment, the push rod 315 is a threaded lead rod. The first driving member 33 is assembled to an end of the fixing bracket 312 opposite to the support seat 10, and is connected to an end of the push rod 315. The support member 35 is assembled to an end of the push rod 315 opposite to the first driving member 33. The support member 35 is positioned on a side of the support seat 10 opposite to the first driving member 33. The first driving member 33 is configured for driving the support member 35 to move relative to the support seat 10, thereby pushing the workpiece to the handling assembly 50.

The handling assembly 50 is mounted on the support seat 10 and is adjacent to the inserting hole 11. The handling assembly 50 includes a mounting seat 51, a transmission subassembly 53, a second driving member 55, and a suction subassembly 57. The mounting seat 51 is mounted on the support seat 10 and is adjacent to the inserting hole 11. The transmission subassembly 53 is assembled to an end of the mounting seat 51 away from the support seat 10. The second driving member 55 is assembled to the mounting seat 51 and is connected to the transmission subassembly 53 for driving the transmission subassembly 53 to slide along X-axis direction (see FIG. 3). The suction subassembly 57 is assembled to an end of the transmission subassembly 53 away from the second driving member 55 for suctioning the workpiece.

The mounting seat 51 includes a mounting portion 512 protruding from an end away from the support seat 10. The mounting portion 512 is parallel to the support seat 10 and is located above the inserting hole 11. The mounting portion 512 is equipped with two transmission wheels 5121 which are spaced apart. The transmission subassembly 53 includes a guiding rod 531 and a transmission belt 535. The guiding rod 531 is movably assembled to the mounting portion 512; a longitudinal direction of the guiding rod 531 is arranged along the X-axis direction. The transmission belt 535 is supported by the guiding rod 531 and resists at a bottom of each transmission wheel 5121. Opposite ends of the transmission belt 535 are fixed to opposite ends of the guiding rod 531, respectively. The second driving member 55 is assembled to the mounting portion 512 and equipped with a driving shaft 551. The driving shaft 551 is positioned above a middle gap generated by the two transmission wheels 5121. The transmission belt 535 is sleeved on the driving shaft 551, and opposite ends of the transmission belt 535 are resisted at the bottom of the two transmission wheels 5121. The second driving member 55 drives the driving shaft 551 to rotate, thereby driving the transmission belt 535 to move the guiding rod 531 along the X-axis. Thus, the guiding rod 531 moves the suction subassembly 57 and aligns the suction subassembly 57 with the push assembly 30.

The suction subassembly 57 includes a fixing member 571 and a plurality of suction members 573 assembled to the fixing member 571. The fixing member 571 is fixedly-assembled to the end of the guiding rod 531 away from the mounting seat 51. The plurality of suction members 573 is arranged separately along a periphery of the fixing member 571. In the embodiment, the suction members 573 are vacuum suction cups. The structure of the suction member 573 may be changed according to a shape and material of the workpiece, such as to that of a magnetic member, if the workpiece is made of magnetic materials.

The uploading assembly 70 is assembled to the support seat 10 and is opposite to the handling assembly 50. The uploading assembly 70 includes a positioning subassembly 71, a transferring subassembly 73, and a third driving member 75. The positioning subassembly 71 is movably assembled to the plurality of sliding grooves 15 and is located below the handling assembly 50. The transferring subassembly 73 is slidably assembled to the pair of guiding rails 13 and is opposite to the positioning subassembly 71. The third driving member 75 is assembled to the support seat 10 and is arranged at a side of the pair of guiding rails 13. The third driving member 75 is connected to the transferring subassembly 73 for moving the transferring subassembly 73 along the pair of guiding rails 13.

The positioning subassembly 71 includes a first bracket 711, a pair of first restricting members 713, and a first screwed rod 715. The first bracket 711 is slidably mounted on the plurality of sliding grooves 15. In the embodiment, the positioning subassembly 71 further includes a buffering member 20 assembled to a side of the plurality of sliding grooves 15 and resisting the first bracket 711. The pair of first restricting members 713 is respectively assembled to opposite sides of the first bracket 711. The first screwed rod 715 is rotatably assembled to the first bracket 711, opposite ends of the first screwed rod 715 is movably extended through the pair of first restricting members 713. In the embodiment, a knob 77 is disposed out of one restricting member 713 and assembled to an end of the first threaded rod 715. When the knob 77 rotates the first threaded rod 715, the pair of first restricting members 713 moves toward or away from each other, thereby, holding the workpiece to the support member 35 or releasing the workpiece to stick or attach to the suction subassembly 57. The workpiece on the support member 35 will not contract due to the restriction of the pair of first restricting members 713. In addition, because the pair of first restricting members 713 can move along the X-axis, it can be employed to clamp workpieces of different sizes. In the embodiment, each first restricting member 713 is equipped with a restricting arm 7131 protruding from an end thereof opposite to the first bracket 711. The pair of restricting arms 7131 can make the workpiece move all the way from the support member 35 along Y-axis.

The transferring subassembly 73 has a structure substantially the same as the positioning subassembly 71. Similarly, the transferring subassembly 73 includes a second bracket 731, a pair of second restricting members 732, and a second screwed rod 735. The difference between the transferring subassembly 73 and the positioning subassembly 71 is that, the second bracket 731 is equipped with a pair of bearing portions 7313 at a bottom thereof, respectively assembled to the pair of guiding rails 13. The third driving member 75 is arranged substantially parallel to the pair of guiding rails 13, and connected to one bearing portion 7313. The third driving member 75 is configured for driving the transferring subassembly 73 to slide along the pair of guiding rails 13, thereby transferring the workpiece to the support member 35 of the push assembly 30.

When in assembly, the fixing bracket 312 of the push assembly 30 is assembled to the side of the support seat 10 opposite to the pair of guiding rails 13, and the support member 35 is aligned to the inserting hole 11. The push rod 315 is extended through the fixing bracket 312 and is partially exposed out of the inserting hole 11. The first driving member 33 is assembled to the end of the fixing bracket 312 away from the support seat 10 and is connected to the push rod 315. The handling assembly 50 is assembled to the support seat 10 and is adjacent to the inserting hole 11. The second driving member 55 is assembled to the mounting portion 512. The guiding rod 531 is movably assembled to the mounting portion 512 and arranged along the X-axis direction. Opposite ends of the transmission belt 535 are fixedly connected to opposite ends of the guiding rod 531. The transmission belt 535 is sleeved on the driving shaft 551 and resists the bottoms of the pair of transmission wheels 5121. The fixing member 571 is assembled to the end of the guiding rod 531 opposite to the mounting seat 51. The plurality of suction members 573 is arranged along the periphery of the fixing member 571. The positioning subassembly 71 is slidably assembled to the plurality of sliding grooves 15. The transferring subassembly 73 is slidably assembled to the pair of guiding rails 13 opposite to the positioning subassembly 71. The third driving member 75 is arrange at a side of the pair of guiding rails 13 and connected to the transferring subassembly 73.

When in use, the first screwed rod 715 is rotated together with the knob 77, the pair of first restricting members 713 moves away from each other until the gap between the pair of first restricting members 713 is suited for the workpiece to fit therein. The transferring subassembly 73 moves along the pair of guiding rails 13 and transfers a workpiece by the pair of bearing portions 7313 to the positioning subassembly 71, and aligns the workpiece to a top of the inserting hole 11. The first driving member 33 drives the support member 35 to move relative to the support seat 10, until the support member 35 supports the workpiece. The third driving member 75 drives the transferring subassembly 73 away from the positioning subassembly 71, thereby releasing the workpiece upon the support member 35. The knob 77 is rotated, and the first screwed rod 715 drives the pair of first restricting members 713 to hold the workpiece, the restricting arms 7131 retains the workpiece. The second driving member 55 drives the driving shaft 551 to rotate, thereby driving the guiding rod 531 to slide along the X-axis via the transmission belt 535, therefore, the suction subassembly 57 is driven by the guiding rod 531 to be aligned with the workpiece. The first driving member 33 drives the support member 35 upward via the transmission member 31. The support member 35 pushes the workpiece from the positioning subassembly 71 to the suction subassembly 57. The suction members 573 of the suction subassembly 57 suction the workpiece, then the second driving member 55 drives the driving shaft 551 to rotate and drives the guiding rod 531 to slide along the X-axis via the transmission belt 535. The guiding rod 531 moves the workpiece to the workstation, and the suction members 573 release the workpiece.

In the handling device 100, the push assembly 30 pushes the workpiece toward the handling assembly 50, and the handling assembly 50 handles the workpiece to the workstation. The first driving member 33 of the push assembly 30 and the second driving member 55 of the handling assembly 50 are capable of working in a predetermined time period, such that the feeding time period or speed of the workstation is accurately controlled, which saves time.

The number of the guiding rails 13 may not be limited to two, but could also be only one or more than two. When the push rod 315 directly extends through the inserting hole 11, the fixing bracket 312 may be omitted. When an end of the push rod 315 opposite to the first driving member 33. A support portion is formed corresponding to the workpiece, and the support member 35 may be omitted. When the workpiece is loaded upon the support member 35 manually, the uploading assembly 70 may be omitted. When the plurality of suction members 573 is separately distributed on the end of the guiding rod 531 away from the second driving member 55, the fixing member 571 may be omitted. When the first driving member 33 is a pneumatic cylinder with an output shaft aligned to the inserting hole 11, for support the workpiece, the transmission member 31 and the support member 35 may be omitted.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A handling device for handling workpiece to a workstation, comprising:
a support seat defining an inserting hole;
a first driving member assembled to the support seat and aligned to the inserting hole; and
a handling assembly, comprising:
a mounting seat assembled to a side of the support seat opposite to the first driving member, the mounting seat being adjacent to the inserting hole;
a transmission subassembly assembled to the mounting seat;
a second driving member assembled to the mounting seat and connected to the transmission subassembly; and
a suction subassembly assembled to the transmission subassembly;
wherein the first driving member extends through the inserting hole and supports a workpiece, the suction subassembly sucks the workpiece, the second driving member drives the transmission subassembly to handle the workpiece to the workstation.

2. The handling device of claim 1, further comprising a transmission member movably extending through the inserting hole, wherein a first end of the transmission member is assembled to the first driving member, a second end of the transmission member opposite to the first end thereof exposes out of the inserting hole and is configured for support the workpiece.

3. The handling device of claim 2, wherein the transmission member comprises a fixing bracket and a push rod, the fixing bracket is fixedly assembled to the support seat and positioned below the inserting hole, the push rod slidably inserts into the fixing bracket and partially extends out of the inserting hole, the first driving member is assembled to an end of the fixing bracket away from the support seat and is connected to the push rod.

4. The handling device of claim 3, further comprising a support member assembled to an end of the push rod opposite to the first driving member, wherein the support member is positioned above the inserting hole, the first driving member is configured for driving the support member to move relative to the support seat via the push rod, thereby push the workpiece to the handling assembly.

5. The handling device of claim 1, wherein the mounting seat comprises a mounting portion protruding from an end thereof away from the support seat, the transmission subassembly is mounted on the mounting portion, and comprises a guiding rod and a transmission belt, the guiding rod is movably assembled to the mounting portion, the transmission belt is supported by the guiding trod, opposite ends of the transmission belt are fixed to opposite ends of the guiding rod, respectively, the suction subassembly is assembled to an end of the guiding rod away from the mounting portion, the second driving member is assembled to the mounting portion and connected to the transmission belt.

6. The handling device of claim 5, wherein the mounting portion is equipped with two transmission wheels spaced from each other, the second driving member is equipped with a driving shaft, the driving shaft is positioned above a middle gap generated by the two transmission wheels, the transmission belt is sleeved on the driving shaft, and opposite ends of the transmission belt resists the bottom of the two transmission wheels.

7. The handling device of claim 5, wherein the suction subassembly comprises a fixing member and a plurality of suction members assembled to the fixing member, the fixing member is fixedly-assembled to the end of the guiding rod away from the mounting seat, the plurality of suction members is arranged separately along a periphery of the fixing member.

8. The handling device of claim 1, wherein the support seat is equipped with a pair of guiding rails and defined a plurality of sliding grooves, the inserting hole is located between the pair of guiding rails, the plurality of sliding grooves is located adjacent to the inserting hole, the handling device further comprises an uploading assembly, the uploading assembly comprises a positioning subassembly, a transferring subassembly, and a third driving member, the positioning subassembly is movably assembled to the plurality of sliding grooves and is located below the handling assembly, the transferring subassembly is slidably assembled to the pair of guiding rails, the third driving member is assembled to the support seat and connected to the transferring subassembly for moving the transferring subassembly along the pair of guiding rails to enable the transferring subassembly to transfer workpiece to the positioning subassembly.

9. The handling device of claim 8, wherein each of the positioning subassembly and the transferring subassembly comprises a bracket, a pair of restricting members, and a screwed rod, the bracket is slidably mounted on the plurality of sliding grooves, the pair of restricting members is respectively assembled to opposite sides of the bracket, the screwed rod is rotatably assembled to the bracket, and opposite ends of the screwed rod movably extend through the pair of restricting members, when the screwed rod is rotated, the pair of restricting members is driven by the screwed rod to move toward or away from each other, thereby holding or releasing the workpiece.

10. The handling device of claim 9, wherein the bracket of the transferring subassembly is equipped with a pair of bearing portions at a bottom thereof, the pair of bearing portions is respectively assembled to the pair of guiding rails, the third driving member is arranged substantially parallel to the pair of second guiding rails, and connected to one bearing portion.

11. A handling device for handling workpiece to a workstation, comprising:
a support seat defining an inserting hole;
a push assembly comprising:
a transmission member assembled to the support seat and extending through the inserting hole;
a first driving member connected to the transmission member; and
a support member connected to the transmission member; and
a handling assembly, comprising:
a mounting seat assembled to a side of the support seat and adjacent to the inserting hole;
a transmission subassembly assembled to the mounting seat;
a second driving member assembled to the mounting seat and connected to the transmission subassembly; and
a suction subassembly assembled to an end of the transmission subassembly;
wherein the first driving member drives the support member upwardly via the transmission member to support a workpiece, the suction subassembly sucks the workpiece, the second driving member drives the transmission subassembly to handle the workpiece to the workstation.

12. The handling device of claim 11, wherein a first end of the transmission member is assembled to the first driving member, a second end of the transmission member opposite to the first end thereof exposes out of the inserting hole and is configured for support the workpiece.

13. The handling device of claim 12, wherein the transmission member comprises a fixing bracket and a push rod, the fixing bracket is fixedly assembled to the support seat and positioned below the inserting hole, the push rod slidably inserts into the fixing bracket and partially extends out of the inserting hole, the first driving member is assembled to an end of the fixing bracket away from the support seat and is connected to the push rod.

14. The handling device of claim 13, wherein the support member is assembled to an end of the push rod opposite to the first driving member, wherein the support member is positioned above the inserting hole, the first driving member is configured for driving the support member to move relative to the support seat via the push rod, thereby push the workpiece to the handling assembly.

15. The handling device of claim 11, wherein the mounting seat comprises a mounting portion protruding from an end thereof away from the support seat, the transmission subassembly is mounted on the mounting portion, and comprises a guiding rod and a transmission belt, the guiding rod is movably assembled to the mounting portion, the transmission belt is supported by the guiding trod, opposite ends of the transmission belt are fixed to opposite ends of the guiding rod, respectively, the suction subassembly is assembled to an end of the guiding rod away from the mounting portion, the second driving member is assembled to the mounting portion and connected to the transmission belt.

16. The handling device of claim 15, wherein the mounting portion is equipped with two transmission wheels spaced from each other, the second driving member is equipped with a driving shaft, the driving shaft is positioned above a middle gap generated by the two transmission wheels, the transmission belt is sleeved on the driving shaft, and opposite ends of the transmission belt resists the bottom of the two transmission wheels.

17. The handling device of claim 15, wherein the suction subassembly comprises a fixing member and a plurality of suction members assembled to the fixing member, the fixing member is fixedly-assembled to the end of the guiding rod away from the mounting seat, the plurality of suction members is arranged along a periphery of the fixing member separately.

18. The handling device of claim 11, wherein the support seat is equipped with a pair of guiding rails and defined a plurality of sliding grooves, the inserting hole is located between the pair of guiding rails, the plurality of sliding grooves is located adjacent to the inserting hole, the handling device further comprises an uploading assembly, the uploading assembly comprises a positioning subassembly, a transferring subassembly, and a third driving member, the positioning subassembly is movably assembled to the plurality of sliding grooves and is located below the handling assembly, the transferring subassembly is slidably assembled to the pair of guiding rails, the third driving member is assembled to the support seat and connected to the transferring subassembly for moving the transferring subassembly along the pair of guiding rails to enable the transferring subassembly to transfer workpiece to the positioning subassembly.

19. The handling device of claim 18, wherein each of the positioning subassembly and the transferring subassembly comprises a bracket, a pair of restricting members, and a screwed rod, the bracket is slidably mounted on the plurality of sliding grooves, the pair of restricting members is respectively assembled to opposite sides of the bracket, the screwed rod is rotatably assembled to the bracket, and opposite ends of the screwed rod movably extend through the pair of restricting members, when the screwed rod is rotated, the pair of restricting members is driven by the screwed rod to move toward or away from each other, thereby holding or releasing the workpiece.

20. The handling device of claim 19, wherein the bracket of the transferring subassembly is equipped with a pair of bearing portions at a bottom thereof, the pair of bearing portions is respectively assembled to the pair of guiding rails, the third driving member is arranged substantially parallel to the pair of second guiding rails, and connected to one bearing portion.
